(19) United States
(12) Patent Application Publication
(10) Pub. No.: US 2016/0092059 A1
(43) Pub. Date: Mar. 31, 2016

(54) WEB-BASED USER INTERFACE DATAFLOW EDITOR

(71) Applicants: Enping Tu, Cupertino, CA (US); Andy Yang, Fremont, CA (US); Yanlun Ma, Saratoga, CA (US); Yung-Yin Chen, Cupertino, CA (US)

(72) Inventors: Enping Tu, Cupertino, CA (US); Andy Yang, Fremont, CA (US); Yanlun Ma, Saratoga, CA (US); Yung-Yin Chen, Cupertino, CA (US)

(21) Appl. No.: 14/500,219

(22) Filed: Sep. 29, 2014

(51) Int. Cl. G06F 3/0486; G06F 3/0482; G06F 17/30; G06F 3/0484

(52) U.S. Cl. CPC G06F 3/0486; G06F 3/04842; G06F 3/0482; G06F 17/3056

(57) ABSTRACT

According to some embodiments, a first drag-and-drop action may be received from a user via a web-based graphical user interface platform to place a first node in a visual dataflow. Similarly, a second drag-and-drop action may be received from the user via the web-based graphical user interface platform to place a second node in the visual dataflow, the second node being directionally connected to the first node. A dataflow creator may then, responsive to said user actions, automatically create a data moving process to move information from a source data repository to a cloud-based destination data repository in accordance with the first and second nodes.

### FIELD

Some embodiments relate to user interfaces. In particular, some embodiments are associated with a web-based user interface dataflow editor.

### BACKGROUND

An enterprise may need to move substantial amounts of information. For example, a company might want to move a large amount of data that exists in a legacy data warehouse to a new cloud-based data repository. In some cases, data items may need to be mapped and/or manipulated before being moved (e.g., a designer might map each data item in a legacy system to a corresponding data item in a cloud-based application and, in some cases, define how a data item should be altered as it is moved). Manually mapping data items can be a time consuming and error-prone task, especially when a substantial number of data items and data item types are involved. For example, a legacy system might have thousands of data items and millions of data records that need to be migrated to a new system. As a result, systems and methods to automatically and accurately facilitate the editing of a dataflow by a user may be desired.

A data item mapping wizard running at an enterprise may help a designer with certain types of mappings. Such an approach, however, is limited to straight forward, linear mappings between data items and may not be appropriate when more complex relationships are required.

### BRIEF DESCRIPTION OF THE DRAWINGS

FIG. 1 illustrates data items that may need to be moved forma source data repository to a cloud-based destination data repository in accordance with some embodiments.

FIG. 2 is a flow diagram of a method in accordance with some embodiments described herein.

FIG. 3 illustrates a display including a reader node according to some embodiments.

FIG. 4 illustrates a display including a loader node in accordance with some embodiments.

FIG. 5 illustrates a display including a transform node in accordance with some embodiments.

FIG. 6 illustrates a dataflow according to some embodiments.

FIG. 7 illustrates another dataflow according to some embodiments.

FIG. 8 illustrates still another dataflow according to some embodiments.

FIG. 9 is a high-level block diagram of a system to facilitate the editing of a dataflow by a user according to some embodiments.

FIG. 10 is an apparatus in accordance with some embodiments described herein.

FIG. 11 is a portion of a tabular data structure for a dataflow database that may be associated with some embodiments described herein.

FIG. 12 is portion of a tabular data structure for a ranking database that may be associated with some embodiments described herein.

FIG. 13 is a flow diagram of a method in accordance with some embodiments described herein.

FIG. 14 illustrates a display including ABAP nodes according to some embodiments.

FIG. 15 is a handheld device that may be provided in accordance with some embodiments.

### DETAILED DESCRIPTION

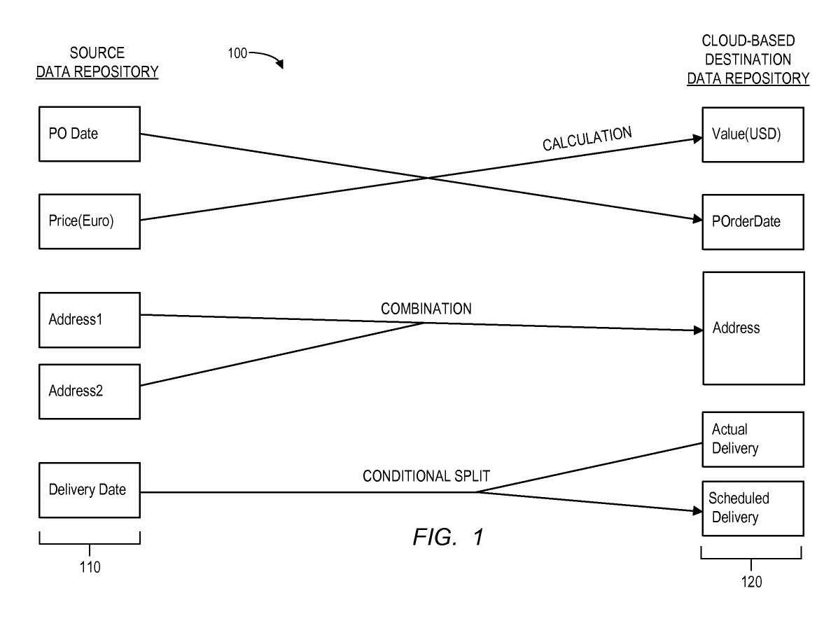

FIG. 1 illustrates data items 100 that may need to be moved forma source data repository 110 to a cloud-based destination data repository 120 in accordance with some embodiments. For example, the “PO Date” in the source data repository 110 should be moved to the “POrderDate” data item in the cloud-based destination data repository 120. Similarly, values in the “Price(Euro)” data item should converted and moved to “Value(USD).” Even more complex relationships include the combination of “Address1” and “Address2” being stored into “Address.” As yet another example, a value in “Delivery Date” may be evaluated and moved into either “Actual Delivery” (if the date is in the past) or “Scheduled Delivery” (if the date is in the future).

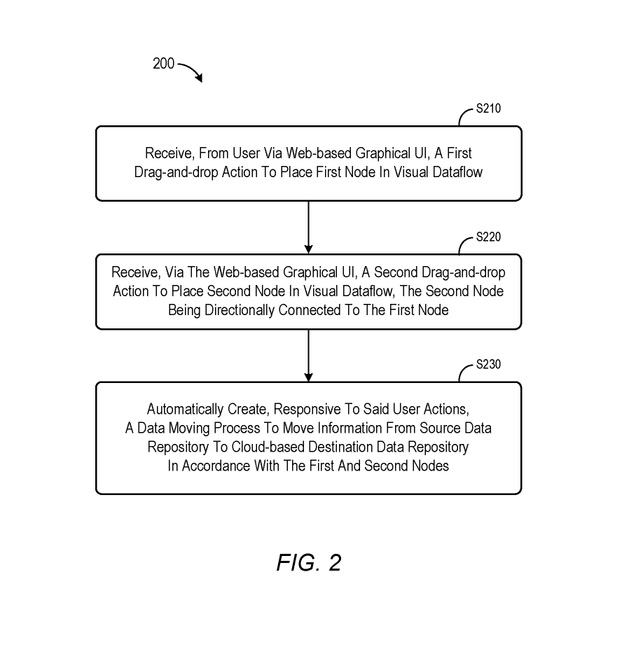

According to some embodiments, a web-based graphical user interface may facilitate such mappings. FIG. 2 is a flow diagram of a method in accordance with some embodiments described herein. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed is by a machine result in performance according to any of the embodiments described herein.

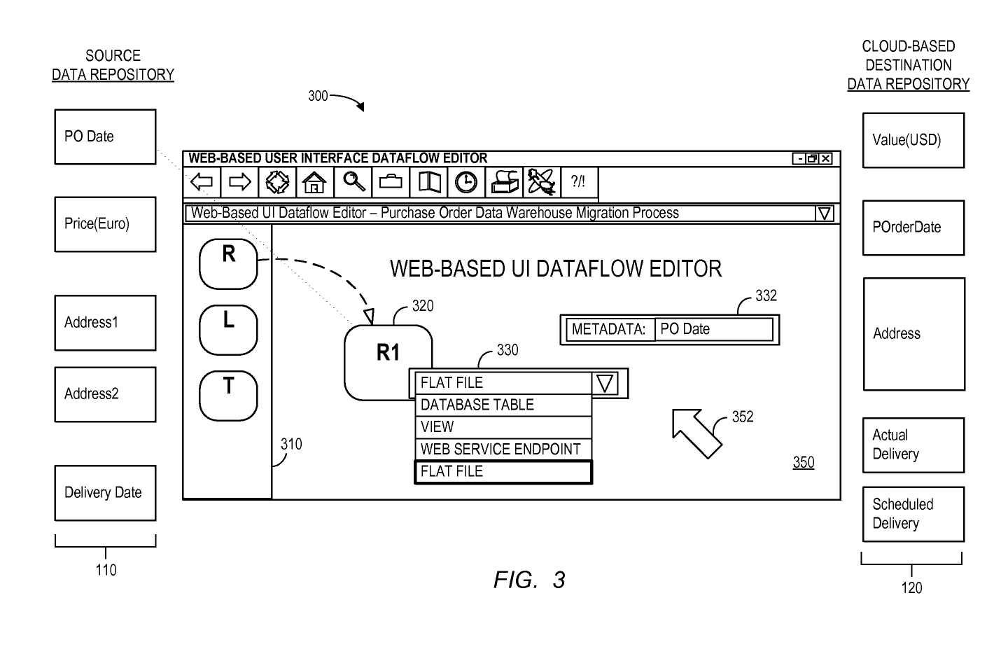

At S210, a first drag-and-drop action to place a first node in a visual “dataflow” may be received from a user via a web-based graphical user interface platform. As used herein, the term “dataflow” may refer to, for example, a container of connected “nodes.” By way of example, a node in a dataflow might comprise a reader node associated with a metadata of source information, the source information being associated with, for example, information in the source data repository 110, a database table, a web service end point, a flat file, and/or a transform node within the dataflow. FIG. 3 illustrates a display 300 including a node selection portion 310 wherein a user can drag-and-drop a reader node icon (e.g., by selecting “R” to create “R1”) onto a dataflow portion 350 using a touch screen or computer pointer 352 according to some embodiments. Responsive to placement of the reader node R1 320, a pop-up window 330 may automatically to the let the user define the type of reader node being added (e.g., the source data item is associated with a “database table”) along with a metadata name entry area 332. According to some embodiments, a reader node may be abstracted to a common Extract/Transform/Load (“ETL”) format. In the example of FIG. 3, R1 is defined as being associated with “PO Date” in the source data repository 110 (as illustrated by the dotted line).

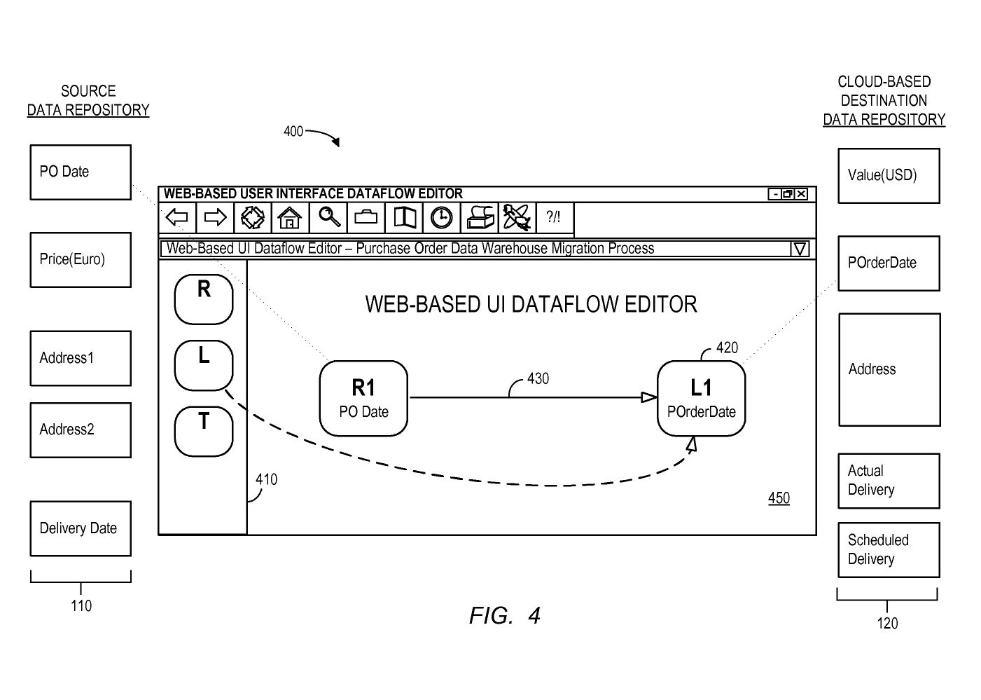

Similarly, and referring again to FIG. 2, at S220 a second drag-and-drop action to place a second node in the visual dataflow may be received from the user via the web-based graphical user interface platform. The second node may be “directionally” connected to the first node. By way of example, a node in a dataflow might comprise a loader node associated with a metadata of target data storage, the target data storage being associated with, for example, information in cloud-based destination data repository 120, a database table, a web service end point, a flat file, and/or a transform node within the dataflow. FIG. 4 illustrates a display 400 including a node selection portion 410 wherein a user can drag-and-drop a loader node icon (e.g., by selecting “L” to create “L1”) onto a dataflow portion 450 using a touch screen or computer pointer according to some embodiments. Responsive to placement of the reader node L1 420, a pop-up window may automatically to the let the user define the type of reader node being is added (e.g., the target data storage is associated with a “web service endpoint”) along with a metadata name entry area. According to some embodiments, a loader node may be abstracted to a common ETL format. In the example of FIG. 4, L1 is defined as being associated with “POrderDate” in the cloud-based destination data repository 120 (as illustrated by the dotted line). Moreover, the loader node L1 420 is directionally connected 430 to receive information from the reader node R1.

Referring again to FIG. 2, at S230 a data moving process may be automatically created (e.g., by a dataflow creator computer processor responsive to said user actions at S210 and/or S220) to move information from a source data repository to a cloud-based destination data repository in accordance with the first and second nodes.

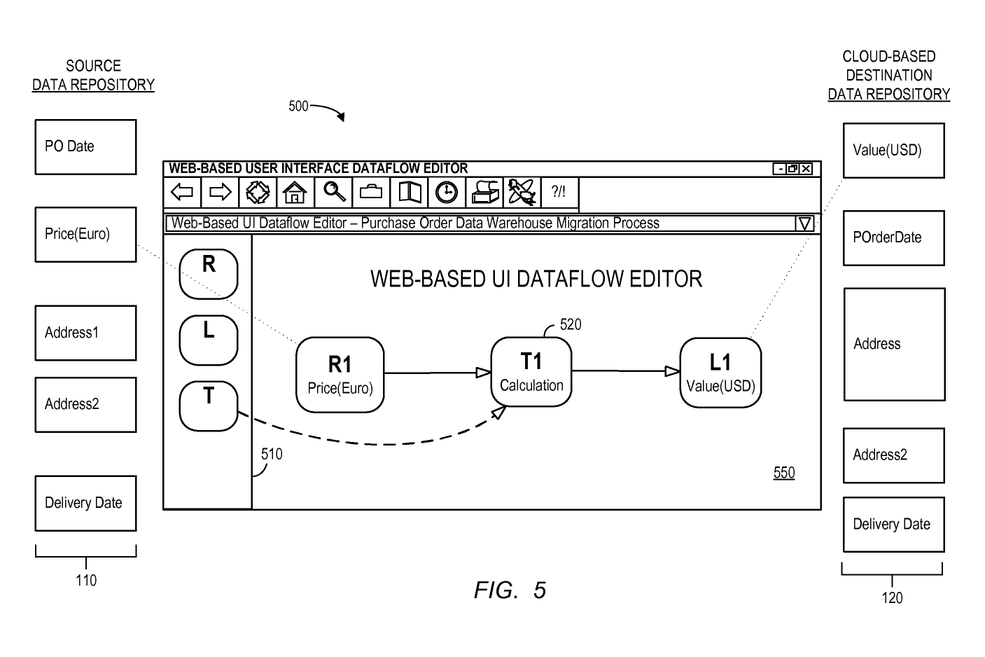

According to some embodiments, a node in a web-based user interface dataflow editor may comprise a “transform node” associated with data manipulation. For example, FIG. 5 illustrates a display 500 including a node selection portion 510 wherein a user can drag-and-drop a transform node (e.g., by selecting “T” to create “T1”) onto a dataflow portion 550 transform node in accordance with some embodiments. Responsive to placement of the transform node T1 520, a pop-up window may automatically to the let the user define the type of data evaluation and/or manipulation being added (e.g., the transform node T1 520 is a calculation to convert euros to dollars). In the example of FIG. 5, T1 is defined as receiving information from reader node R1 (“Price(Euro)”) and providing information to loader node L1 (“Value(USD)”). Note that a transform node might get input from a reader node or another transform node, do a calculation upon the incoming data, and output the calculation result to a loader node or another transform node. According to some embodiments, responsive to a drag-and-drop user action, the system may verify that the visual dataflow is allowable. For example, a reader node should not receive information from a loader node or a transform node.

According to some embodiments, the web-based user interface dataflow editor may be associated with a graphic JavaScript library. Moreover, embodiments may be associated with the HyperText Markup Language (“HTML”) version 5 protocol and/or the win32 User Interface (“UI”) Application Programming Interface (“API”) to facilitate drag-and-drop functionality for nodes and node connections. Moreover, embodiments may be associated with the migration of Data Service on Demand (“DSoD”) data items.

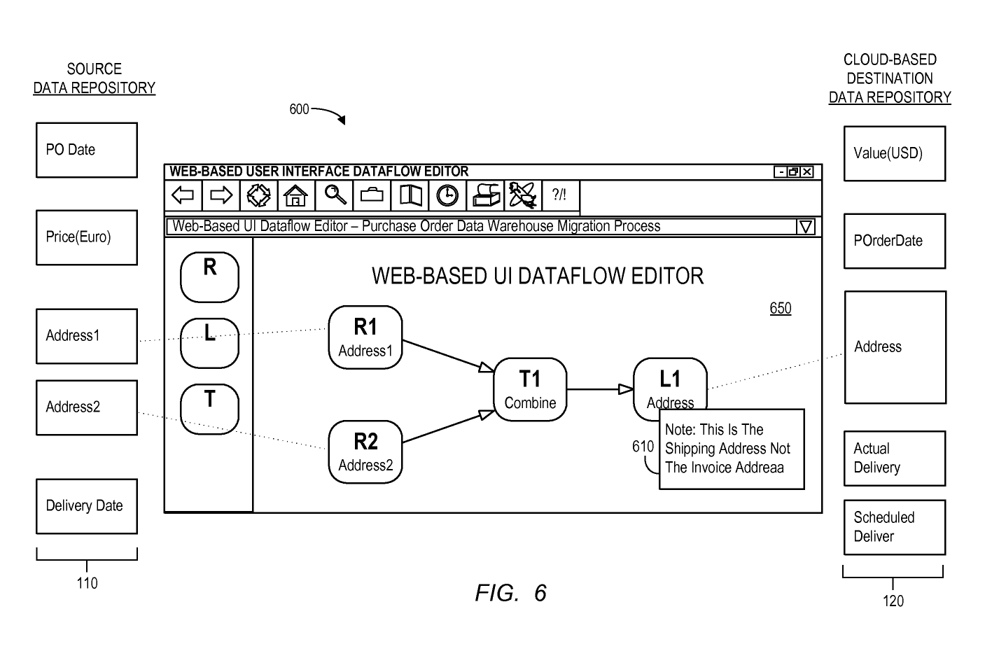

FIGS. 6 through 8 illustrate various types of dataflows according to some embodiments. In particular, FIG. 6 illustrates a display 600 including a dataflow 650 wherein two reader nodes R1 and R2 are associated with “Address1” and “Address2” data items in the source data repository 110 and each provides data to a “combine” transform node T1. The combine transform node T1 creates a single data item from the two sources and provides the new data item to loader node L1 (associated with the single “Address” data item in the cloud-base destination data repository 120). According to some embodiments, user annotation information associated with a node may be received from a user via a data entry area 610 to be stored in association with that node. In this way, a user can add comments to enhance the readability of the dataflow 650.

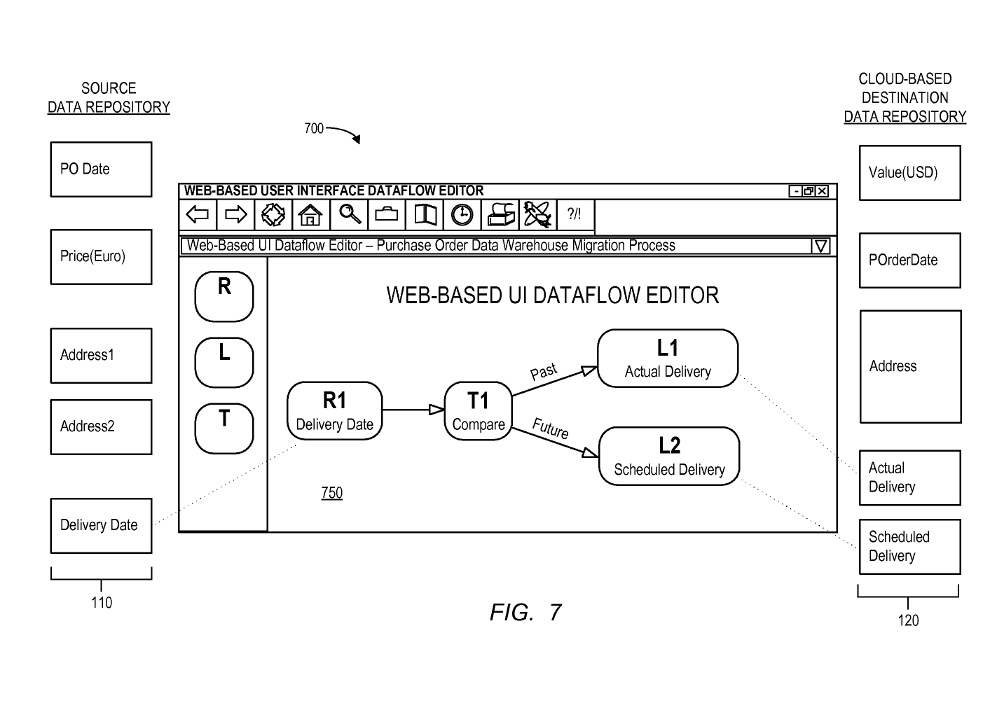

FIG. 7 illustrates a display 700 including a dataflow 750 wherein a reader node R1 is associated with “Delivery Date” data item in the source data repository 110 and provides data to a “compare” transform node T1. The compare transform node T1 evaluates to received date and stores it into either a loader node L1 (associated with the “Actual Delivery” data item in the cloud-base destination data repository 120 when the date is in past) or a loader node L2 (“associated with the “Scheduled Delivery” data item in the cloud-base destination data repository 120 when the date is in the past).

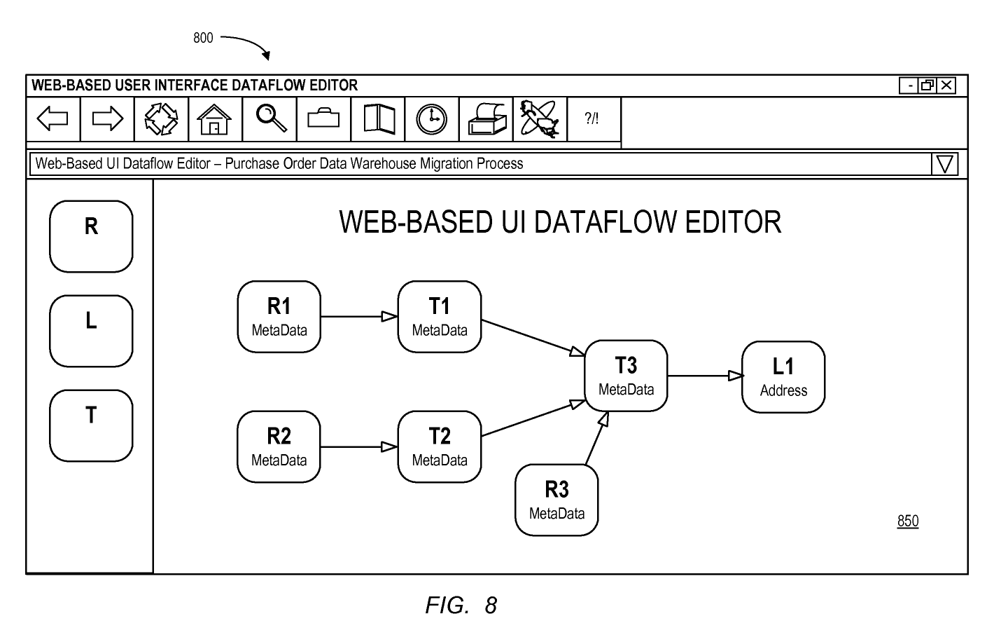

FIG. 8 illustrates a display 800 including a dataflow 850 wherein a reader node R1 provides information to a transform node T1. Similarly, a reader node R2 provides information to a transform node T2. Another transform node T3 receives the results of transform node T1 and transform node T2, along with data from another reader node R3, and provides an output to a loader node L1. Thus, users may be able to graphically drag-and-drop icons to arrange nodes in any number of ways to create an appropriate dataflow. When connecting two nodes, embodiments check the types of two nodes to decide if it is an allowable connection, build necessary the relationships in backend, and save the new relationship to a database.

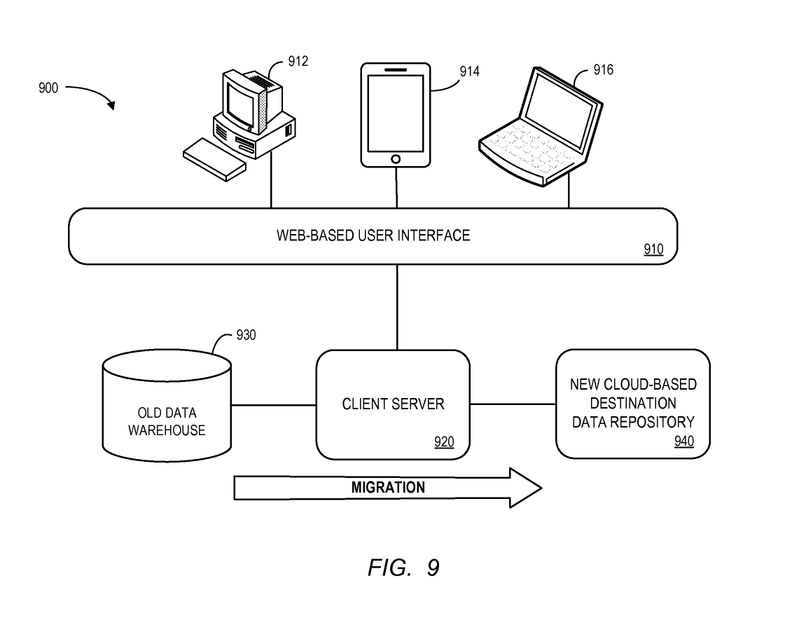

FIG. 9 is a high-level block diagram of a system 900 to facilitate information migrations according to some embodiments. The system 900 may be associated with, for example, an enterprise service cloud based environment accessed by user devices 910, 912, 914. The enterprise service cloud may be supported by an enterprise service cloud infrastructure layer (e.g., a private and/or public cloud infrastructure) to provide is application services (e.g., native applications, Java cloud applications, portals, mobile device support, collaboration features, and/or integration abilities) and database services (e.g., in-memory, transactional, analytics, text, predictive, planning, etc.). Note that the database services may support multiple tenants. By way of example only, the system 900 may be associated with a HANA cloud platform from SAP®.

According to this embodiment, a user may access user devices 912, 914, 916 to define a dataflow for a client server 920 via a web-based user interface 910. In this way, the dataflow may be used by the client server 920 to properly move information from an old data warehouse 930 to a new cloud-based destination data repository 940 in an automated and efficient manner.

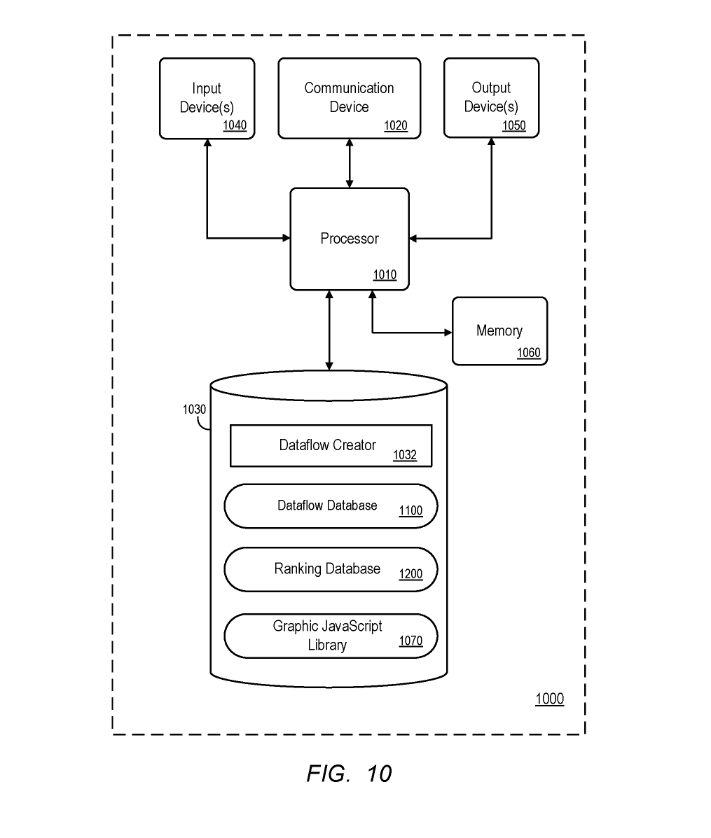

Embodiments described herein may be implemented using any of a number of different hardware configurations. For example, FIG. 10 is a block diagram of an apparatus 1000 according to some embodiments. The apparatus 1000 may comprise a general-purpose computing apparatus and may execute program code to perform any of the functions described herein. The apparatus 1000 may include other unshown elements according to some embodiments.

The apparatus 1000 includes a processor 1010 operatively coupled to a communication device 1020, a data storage device 1030, one or more input devices 1040, one or more output devices 1050 and a memory 1060. The communication device 1020 may facilitate communication with external devices, such as a remote client or database device. The input device(s) 1040 may comprise, for example, a keyboard, a keypad, a computer mouse or other pointing device, a microphone, an Infra-Red (“IR”) port, a docking station, and/or a touch screen. The input device(s) 1040 may be used, for example, to enter information about dataflow nodes into apparatus 1000. The output device(s) 1050 may comprise, for example, a display (e.g., a display screen) a speaker, and/or a printer and may be used to generate logs, reports, etc.

The data storage device 1030 may comprise any appropriate persistent storage device, including combinations of magnetic storage devices (e.g., magnetic tape, hard disk drives and flash memory), optical storage devices, Read Only Memory (“ROM”) devices, etc., while memory 1060 may comprise Random Access Memory (“RAM”).

Program code of a migration engine 1032 may be executed by the processor 1010 to cause the apparatus 1000 to perform any one or more of the processes described herein. Embodiments are not limited to execution of these processes by a single apparatus. The data storage device 1030 may also store data and other program code for providing additional functionality and/or which are necessary for operation thereof, such as device drivers, operating system files, etc. For example, the processor 1010 may receive a first drag-and-drop action from a user via a web-based graphical user interface platform to place a first node in a visual dataflow. Similarly, the processor 1010 may receive a second drag-and-drop action the user via the web-based graphical user interface platform to place a second node in the visual dataflow, the second node being directionally connected to the first node. The processor 1010 may then, responsive to said user actions, automatically create a data moving process to move information from a source data repository to a cloud-based destination data repository in accordance with the first and second nodes.

Note that the data storage device 1030 may further store a dataflow database 1100, a ranking database 1200, and/or a graphic JavaScript library 1070 (e.g., to facilitate a drag-and-drop user interface dataflow editor).

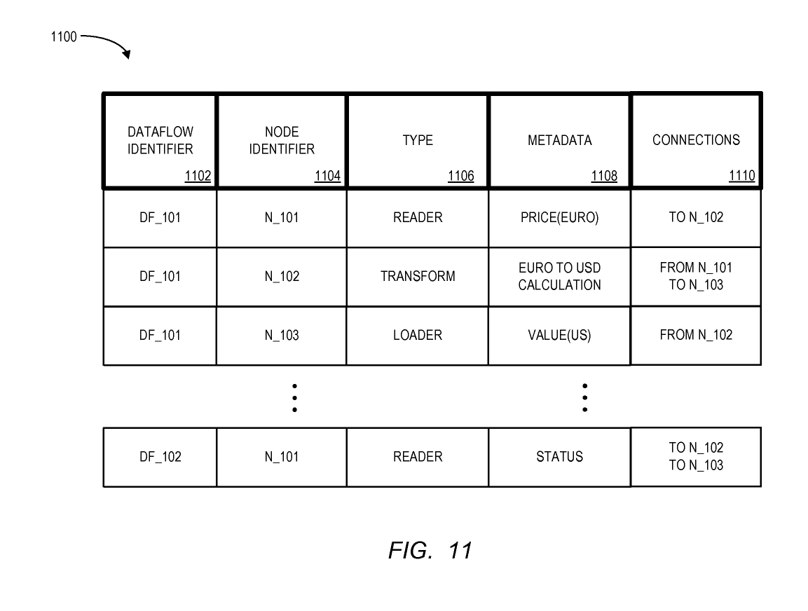

Referring to FIG. 11, a table is shown that represents a dataflow database 1100 that may be stored at the apparatus 1000 according to some embodiments. The table may include, for example, entries identifying nodes that define dataflows. The table may also define fields 1102, 1104, 1106, 1108, 1110 for each of the entries. The fields 1102, 1104, 1106, 1108, 1110 may, according to some embodiments, specify: a dataflow identifier 1102, a node identifier 1104, a type 1106, metadata 1108, and connections 1110. The dataflow database 1100 may be created and updated, for example, via a web-based user interface dataflow editor.

The dataflow identifier 1102 may be, for example, a unique alphanumeric code identifying a dataflow that defines data item mappings. The node identifier 1104 may be, for example, a unique alphanumeric code identifying the nodes that comprise each dataflow. The type 1106 may indicate the type of node (reader, transform, loader) and the metadata 1108 might define a related data item, a type of data transformation, etc. Finally, the connections 1110 may define how the nodes are directionally related to each is other. Note that the three nodes comprising dataflow identifier 1102 “DF_101” may be associated with, for example, the dataflow 550 illustrated in FIG. 5.

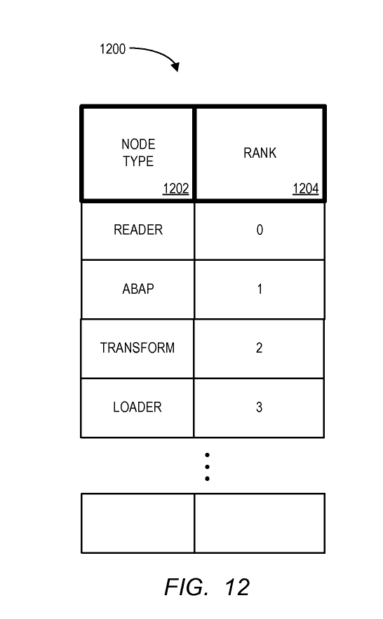

According to some embodiments, the apparatus 1000 may verify that a visual dataflow is allowable responsive to a drag-and-drop user action. In particular, node types may be ranked such that no connection is allowed between nodes if a “form” node has a higher rank than a “to” node. Referring to FIG. 12, a table is shown that represents a ranking database 1120 that may be stored at the apparatus 1000 according to some embodiments. The table may include, for example, entries identifying types of nodes that may define dataflows. The table may also define fields 1202, 1204 for each of the entries. The fields 1202, 1204 may, according to some embodiments, specify: a node type identifier 1202 and an associated node rank 1204. The ranking database 1200 may be created and updated, for example, by a designer or database manager.

The node 1202 may be, for example, a unique alphanumeric code identifying a type of node that may be included in a dataflow and may be equal to or based on the type 1104 in the dataflow database 1100. The rank 1204 may indicate which connections are allowable for that node type 1202. For example, a loader node (rank “3”) cannot send information to a reader node (rank “0”) because it has a lower value.

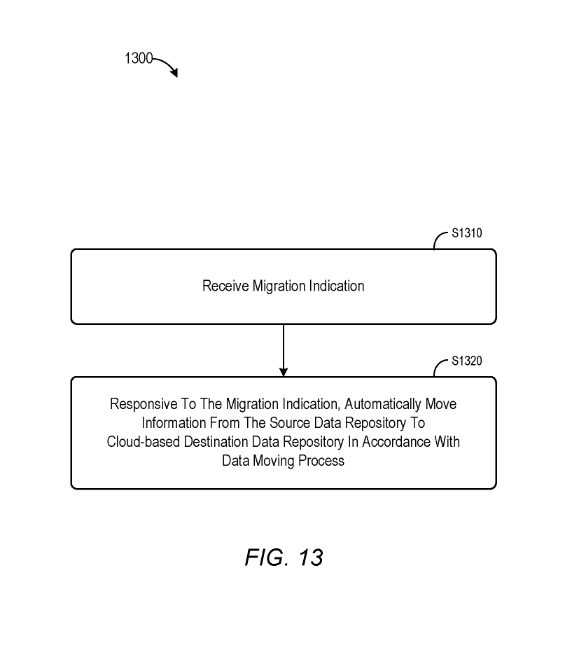

Thus, embodiments may let a user create a dataflow to facilitate information migrations to a cloud-based data repository. Once the dataflow is complete, a user may initiate the movement of information from the source to the destination in accordance with the dataflow. For example, FIG. 13 is a flow diagram of a method in accordance with some embodiments described herein. At S1310, a migration indication may be received. For example, a user might select a “begin migration” icon on a display.

Responsive to the migration indication, at S1320 embodiments may automatically move information from a source data repository to a cloud-based destination data repository in accordance with the data moving process created based on the dataflow defined by the user. In this way, the user may access the intuitive web-based dataflow editor to define a complex migration process and then use that definition to initiate an actual migration of a substantial amount of information.

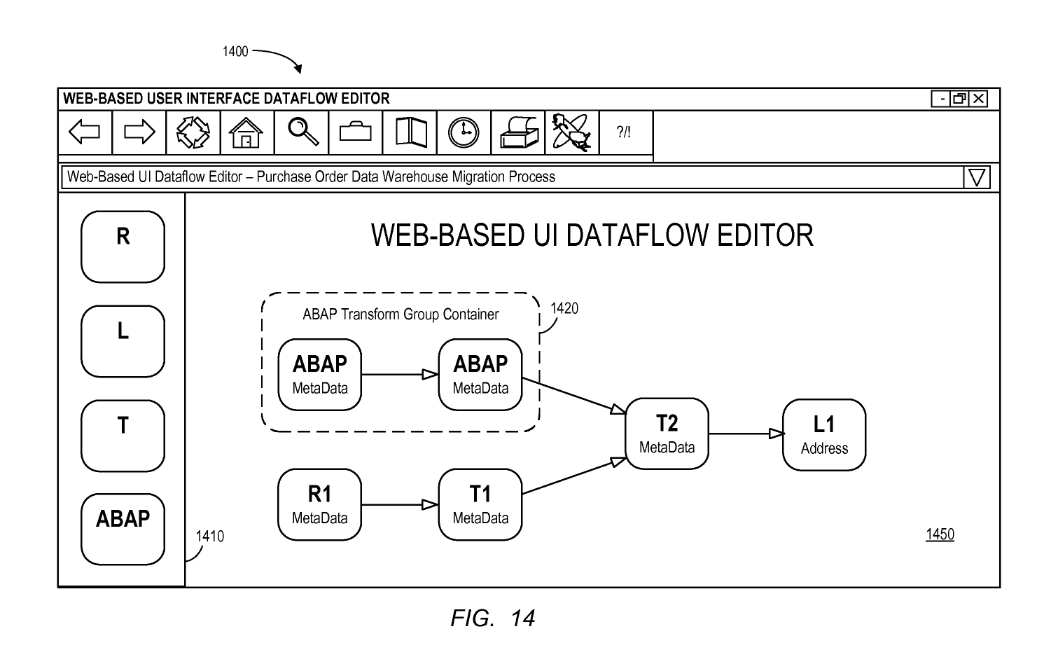

In some case, a data migration may be associated with the Advanced Business Application Programming (“ABAP”) protocol. For example, FIG. 14 illustrates a display is 1400 including ABAP nodes dragged from a node selection area 1410 according to some embodiments. When the system detects an ABAP drag-and-drop action it may automatically create an ABAP transform group container 1420 in the visual dataflow 1450 for that node. Note that an ABAP query related transform node may need to be located at the very beginning of a dataflow. Moreover, no other type of transform may be inserted between two ABAP query transforms, and only the last node in an ABAP query transform chain may comprise an input to another transform node. Thus, when the user drags-and-drops his or her first ABAP query transform node into the editor, the system may automatically create the ABAP transform group 1420. When the user drags-and-drops additional ABAP query transforms nodes into the editor, he or she may only be allowed to drop them into that existing ABAP transform group 1420. That is, no ABAP Query transform nodes can connect to outside of the ABAP transform group 1420 (that is, the ABAP transform group 1420 may be considered as a special transform and can only be input of other nodes behind it. Referring to the ranking database 1200 of FIG. 12, for example, the reader node has a rank of “0” and the ABAP transform node has a rank “1.” As a result, a use cannot connect from an ABAP query transform node to a reader node in the dataflow.

Thus, embodiments may provide for the automated and efficient creation of a dataflow by a user.

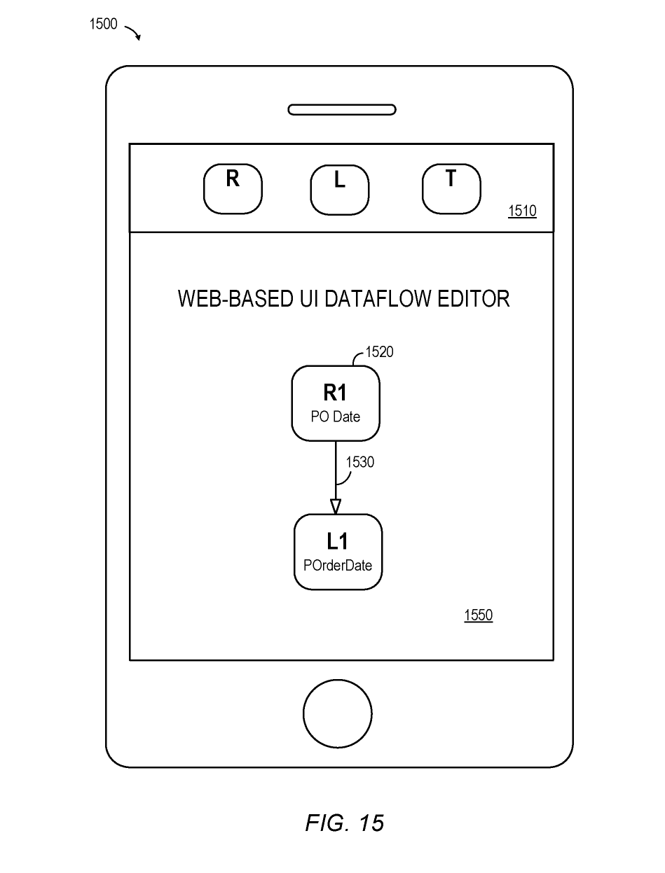

The foregoing diagrams represent logical architectures for describing processes according to some embodiments, and actual implementations may include more or different components arranged in other manners. Other topologies may be used in conjunction with other embodiments. Moreover, each system described herein may be implemented by any number of devices in communication via any number of other public and/or private networks. Two or more of such computing devices may be located remote from one another and may communicate with one another via any known manner of network(s) and/or a dedicated connection. Each device may comprise any number of hardware and/or software elements suitable to provide the functions described herein as well as any other functions. For example, any computing device used in an implementation of the system 900 may include a processor to execute program code such that the computing device operates as described herein. As another example, although is particular types of displays have been provided as example, any other type of user interface may be provided instead of, or in addition to, those described. For example, FIG. 15 is a handheld device 1500 that may be provided in accordance with some embodiments. The handheld device 1500 may be associated with a smartphone, tablet computer, etc. and may include a node selection portion 1510 where a user can, via a touchscreen, drag-and-drop icons to create a dataflow 1550 (e.g., including reader node R1 1520, loader node L1, connections 1530, etc.). All systems and processes discussed herein may be embodied in program code stored on one or more computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

Elements described herein as communicating with one another are directly or indirectly capable of communicating over any number of different systems for transferring data, including but not limited to shared memory communication, a local area network, a wide area network, a telephone network, a cellular network, a fiber-optic network, a satellite network, an infrared network, a radio frequency network, and any other type of network that may be used to transmit information between devices. Moreover, communication between systems may proceed over any one or more transmission protocols that are or become known, such as Asynchronous Transfer Mode (“ATM”), Internet Protocol (“IP”), Hypertext Transfer Protocol (“HTTP”) and Wireless Application Protocol (“WAP”).

Embodiments described herein are solely for the purpose of illustration. Those in the art will recognize other embodiments may be practiced with modifications and alterations to that described above.

What is claimed is:

1. A computer-implemented method, comprising:
receiving, from a user via a web-based graphical user interface platform, a first drag-and-drop action to place a first node in a visual dataflow;
receiving, from the user via the web-based graphical user interface platform, a second drag-and-drop action to place a second node in the visual dataflow, the second node being directionally connected to the first node; and
automatically creating, by a dataflow creator computer processor responsive to said user actions, a data moving process to move information from a source data repository to a cloud-based destination data repository in accordance with the first and second nodes.

2. The method of claim 1, wherein at least one of the first and second nodes comprise a reader node associated with metadata of source information, the source information being associated with at least one of: (i) information in the source data repository, (ii) a database table, (iii) a web service end point, (iv) a flat file, and (v) a transform node within the dataflow.

3. The method of claim 1, wherein at least one of the first and second nodes comprise a loader node associated with metadata of destination information, the destination information being associated with at least one of: (i) information in the cloud-based destination data repository, (ii) a database table, (iii) a web service end point, (iv) a flat file, and (v) a transform node within the dataflow.

4. The method of claim 1, wherein at least one of the first and second nodes comprises a transform node associated with data manipulation.

5. The method of claim 1, further comprising:
responsive to said first drag-and-drop user action, requesting metadata input from the user.

6. The method of claim 1, further comprising:
responsive to said second drag-and-drop user action, verifying that the visual dataflow is allowable.

7. The method of claim 1, the method of claim 1, further comprising:
receiving from the user annotation information associated with the first node; and
storing said annotation information in association with the first node.

8. The method of claim 1, wherein the first node comprises an Advanced Business Application Programming (“ABAP”) node, and responsive to said first drag-and-drop action:
automatically creating an ABAP transform group container in the visual dataflow for the first node.

9. The method of claim 1, further comprising:
receiving a migration indication; and
responsive to the migration indication, automatically moving information from the source data repository to the cloud-based destination data repository in accordance with the data moving process.

10. The method of claim 1, wherein the web-based user interface is associated with at least one of: (i) a graphic JavaScript library, and (ii) a HyperText Markup Language version 5 protocol.

11. A non-transitory computer-readable medium storing program code, the program code executable by a computer processor to perform a method, wherein the method comprises:
receiving, from a user via a web-based graphical user interface platform, a first drag-and-drop action to place a first node in a visual dataflow;
receiving, from the user via the web-based graphical user interface platform, a second drag-and-drop action to place a second node in the visual dataflow, the second node being directionally connected to the first node; and
automatically creating, by a dataflow creator computer processor responsive to said user actions, a data moving process to move information from a source data repository to a cloud-based destination data repository in accordance with the first and second nodes.

12. The medium of claim 11, wherein at least one of the first and second nodes comprise a reader node associated with metadata of source information, the source information being associated with at least one of: (i) information in the source data repository, (ii) a database table, (iii) a web service end point, (iv) a flat file, and (v) a transform node within the dataflow.

13. The method of claim 11, wherein at least one of the first and second nodes comprise a loader node associated with metadata of destination information, the destination information being associated with at least one of: (i) information in the cloud-based destination data repository, (ii) a database table, (iii) a web service end point, (iv) a flat file, and (v) a transform node within the dataflow.

14. The medium of claim 11, wherein at least one of the first and second nodes comprise a transform node associated with data manipulation.

15. The medium of claim 11, further comprising:
responsive to said first drag-and-drop user action, requesting metadata input from the user.

16. The medium of claim 11, further comprising:
responsive to said second drag-and-drop user action, verifying that the visual dataflow is allowable.

17. The medium of claim 11, wherein the first node comprises an Advanced Business Application Programming (“ABAP”) node, and responsive to said first drag-and-drop action:
automatically creating an ABAP transform group container in the visual dataflow for the first node.

18. A system, comprising:
a communication receive information from a user device; and
a computer processor coupled to the communication device device and configured to: (i) receive, from the user device, a first drag-and-drop action to place a first node in a visual dataflow; (ii) receive, from the user device, a second drag-and-drop action to place a second node in the visual dataflow, the second node being directionally connected to the first node; and (iii) automatically create a data moving process to move information from a source data repository to a cloud-based destination data repository in accordance with the first and second nodes.

19. The system of claim 18, wherein at least one of the first and second nodes comprise a reader node associated with metadata of source information, the source information being associated with at least one of: (i) information in the source data repository, (ii) a database table, (iii) a web service end point, (iv) a flat file, and (v) a transform node within the dataflow.

20. The system of claim 18, wherein at least one of the first and second nodes comprise a loader node associated with metadata of destination information, the destination information being associated with at least one of: (i) information in the cloud-based destination data repository, (ii) a database table, (iii) a web service end point, (iv) a flat file, and (v) a transform node within the dataflow.

21. The system of claim 18, wherein at least one of the first and second nodes comprises a transform node associated with data manipulation.

22. The system of claim 18, wherein the computer processor is further to, responsive to said first drag-and-drop user action, request metadata input from the user.
